(19) United States
(12) Patent Application Publication
(10) Pub. No.: US 2025/0207733 A1
(43) Pub. Date: Jun. 26, 2025

(54) STORAGE TANK ASSEMBLY, STORAGE TANK-RAIL ASSEMBLY, AND VEHICLE

(71) Applicants: Hyundai Motor Company, Seoul (KR); Kia Corporation, Seoul (KR)

(72) Inventor: Myung Ju JUNG, Yongin-Si (KR)

(73) Assignees: Hyundai Motor Company, Seoul (KR); Kia Corporation, Seoul (KR)

(21) Appl. No.: 18/784,223

(22) Filed: Jul. 25, 2024

(30) Foreign Application Priority Data
Dec. 20, 2023 (KR) 10-2023-0187379

(51) Int. Cl. F17C 13/08

(52) U.S. Cl. CPC F17C 13/084; F17C 2205/0107; F17C 2205/013; F17C 2205/0173; F17C 2205/0323; F17C 2270/0184

(57) ABSTRACT

A storage tank assembly includes a storage tank extending along a first direction, that stores a fluid in an interior thereof, and including a discharge hole at an end portion of the storage tank in the first direction, and a connecting portion coupled to the discharge hole, and including an internal passage fluidically-communicating with the discharge hole, in an interior of the connecting portion, and the connecting portion includes a connecting portion body including the internal passage in an interior of the connecting portion body, and a rail insertion groove formed to be recessed from the connecting portion body and configured so that a rail provided on an outside of the connecting portion body is selectively inserted thereinto.

### CROSS-REFERENCE TO RELATED APPLICATION

The present application claims priority to Korean Patent Application No. 10-2023-0187379, filed on Dec. 20, 2023, the entire contents of which is incorporated herein for all purposes by this reference.

### BACKGROUND OF THE PRESENT DISCLOSURE

### Field of the Present Disclosure

The present disclosure relates to a storage tank assembly, a storage tank-rail assembly, and a vehicle.

### Description of Related Art

A fuel cell electric vehicle (FCEV) refers to a vehicle which is driven by supplying electric power to an electric motor with fuel cells. The FCEV utilizes hydrogen as a fuel. Accordingly, to use hydrogen as a fuel, hydrogen is filled in a hydrogen storage tank. Recently, to reduce a space dependence, a form of a plurality of small-diameter hydrogen storage tanks that are obtained by downscaling hydrogen storage tanks has been developed.

However, when the such small-diameter hydrogen storage tanks are used, each tank requires mounting of a valve or case for connection, which increases an overall weight thereof, whereby a hydrogen storage per weight is decreased.

Furthermore, the present small-diameter hydrogen storage tank includes a structure which is fixed to an interior of the vehicle. That is, for charging, hydrogen has to be filled in an interior of a small-diameter hydrogen storage tank which is mounted on the vehicle, and it has a structure that makes it impossible to attach and detach a separate tank for increasing a range.

Accordingly, it is impossible to increase the range by adding a separate tank later or to reduce the weight of the vehicle by separating the tank, in which all the hydrogen therein is completely discharged.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a storage tank assembly including a structure that allows a storage tank to be detachable from the vehicle, a storage tank-rail assembly, and a vehicle.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a storage tank assembly includes a storage tank extending along a first direction, that stores a fluid in an interior thereof, and including a discharge hole at an end portion of the storage tank in the first direction, and a connecting portion coupled to the discharge hole, and including an internal passage fluidically-communicating with the discharge hole, in an interior of the connecting portion, and the connecting portion includes a connecting portion body including the internal passage in an interior of the connecting portion body, and a rail insertion groove formed to be recessed from the connecting portion body and configured so that a rail provided on an outside of the connecting portion body is selectively inserted thereinto.

In another exemplary embodiment of the present disclosure, when one direction crossing the first direction is defined as a second direction, the connecting portion may further include a protruding portion protruding from an end portion of the connecting portion body in the second direction along the second direction, and an interior of which fluidically communicates with the internal passage, and a groove portion formed to be recessed from an end portion of the connecting portion body in an opposite direction to the second direction along the second direction, and fluidically-communicating with the internal passage.

In another exemplary embodiment of the present disclosure, the connecting portion may further include a valve member passing through the connecting portion body along the first direction and an opposite direction to the first direction, disposed to overlap the internal passage when viewed along the first direction, and that selectively closes the internal passage.

In another exemplary embodiment of the present disclosure, the valve member may be located on a side of the discharge hole in the opposite direction to the second direction.

In another exemplary embodiment of the present disclosure, a plurality of storage tanks and a plurality of connecting portions are provided, and each of the connecting portion may include a constraint member configured so that a portion thereof is disposed at the groove portion to constrain a protruding portion of another connecting portion inserted into the groove portion, and a movement member engaged to the constraint member, and that moves the constraint member so that the constraint member becomes farther away from or closer to the protruding portion in operation of the movement member.

In another exemplary embodiment of the present disclosure, the protruding portion may include an inclined area being an area, a diameter of which increases along the second direction or the opposite direction to the second direction, and the protruding portion may be pressed in the second direction or the opposite direction to the second direction when the inclined area contacts with the constraint member.

In another exemplary embodiment of the present disclosure, when one direction crossing the first direction and the second direction is defined as a third direction, the connecting portion may further include a fastening hole formed on a side of the connecting portion body in at least one of the third direction or an opposite direction thereto, and configured so that a fastening member passing through the rail along the third direction or the opposite direction to the third direction is inserted thereinto.

In another exemplary embodiment of the present disclosure, the rail insertion groove may be formed on a side of the connecting portion body in the third direction or the opposite direction to the third direction, and extending along the second direction.

In another exemplary embodiment of the present disclosure, the fastening hole and the rail insertion groove may be communicated with each other.

In another exemplary embodiment of the present disclosure, when one direction crossing the first direction is defined as a second direction, the connecting portion may further include a connecting member formed on a side of the connecting portion body in the second direction or the opposite direction to the second direction, and selectively positioned in a communication state, in which the connecting member is communicated with the internal passage, and a closed state, in which the connecting member is not communicated with the internal passage, and a hose member which is engaged with the connecting member, and that switches the connecting member from the closing state to the communication state when being engaged with the connecting member.

According to an aspect of the present disclosure, a storage tank-rail assembly includes a storage tank assembly including a storage tank extending along a first direction, and a connecting portion connected to a side of the storage tank in the first direction, and a rail extending in a second direction being one direction crossing the first direction, and engaged with the connecting portion, a discharge hole is formed at an end portion of the storage tank in the first direction, and the connecting portion includes a connecting portion body including an internal passage fluidically-communicating with the discharge hole, in an interior of the connecting portion, and a rail insertion groove formed to be recessed from the connecting portion body, and configured so that the rail is inserted thereinto.

In another exemplary embodiment of the present disclosure, a plurality of storage tank assemblies may be provided, and connecting portions of the plurality of storage tank assemblies may be connected to each other.

In another exemplary embodiment of the present disclosure, the connecting portion may further include a protruding portion protruding from an end portion of the connecting portion body in the second direction along the second direction, and fluidically-communicating with the internal passage, and a groove portion formed to be recessed from an end portion of the connecting portion body in an opposite direction to the second direction along the second direction, and fluidically-communicating with the internal passage, and a protruding portion of another connecting portion may be inserted into a groove portion of any one connecting portion.

In another exemplary embodiment of the present disclosure, when one direction crossing the first direction and the second direction is defined as a third direction, the rail may include a pair of rail members spaced from each other along the third direction, the rail may include a first rail area, in which a spacing distance of the pair of rail members is a first spacing distance, and a second rail area, in which the spacing distance of the pair of rail members is a second spacing distance being greater than the first spacing distance, and the first rail area and the second rail area may be alternately disposed along the second direction.

In another exemplary embodiment of the present disclosure, the rail insertion groove may be formed on one side of the connecting portion body in at least one of the third direction or an opposite direction thereto, and may extend along the second direction, a length of the connecting portion body in the third direction may correspond to the first spacing distance, and a length of the connecting portion body in the second direction may correspond to the second spacing distance.

In another exemplary embodiment of the present disclosure, the connecting portion may further include a fastening hole formed on a side of the connecting portion body in at least one of the second direction or an opposite direction thereto, the rail may further include a rail fastening hole formed in the second rail area, and fluidically-communicating with the fastening hole to pass through the fastening member, and the connecting portion may be located in the second rail area, and the fastening hole and the rail fastening hole may fluidically communicate with each other as the connecting portion is disposed in a state, in which the connecting portion is rotated by 90 degrees from a state, in which the connecting portion is located in the first rail area.

According to an aspect of the present disclosure, a vehicle includes a vehicle body, a storage tank assembly including a storage tank extending along a first direction, and a connecting portion connected to a side of the storage tank in a first direction, and a rail extending in a second direction being one direction crossing the first direction, engaged with the connecting portion, and coupled to the vehicle body, and the storage tank assembly is separably engaged with the rail.

In another exemplary embodiment of the present disclosure, wherein the rail may be coupled to at least one of a lower portion of the vehicle body, a trunk of the vehicle body, a rear side of a rear seat in the vehicle body, and an upper portion of the vehicle body.

In another exemplary embodiment of the present disclosure, the rail may include an upper rail member, and a lower rail member disposed on a lower side of the upper rail member to be symmetrical thereto, opposite end portions of the lower rail member may be fixed to the vehicle body, and one end portion of the upper rail member may be fixed to the vehicle body to allow a change due to pressing of the connecting portion.

In another exemplary embodiment of the present disclosure, the vehicle may further include a fixed storage tank fixedly coupled to the vehicle body, and configured so that a fluid is kept in an interior of the fixed storage tank.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a storage tank assembly according to various exemplary embodiments of the present disclosure;

FIG. 2 is a perspective view of a connecting portion of a storage tank assembly according to various exemplary embodiments of the present disclosure;

FIG. 3 is a perspective view of the connecting portion of FIG. 2, viewed from another direction thereof;

FIG. 4 is a perspective view of a storage tank-rail assembly according to various exemplary embodiments of the present disclosure;

FIG. 5 is a cross-sectional view of a storage tank assembly according to various exemplary embodiments of the present disclosure;

FIG. 6 is a view exemplarily illustrating a state, in which a valve member closes an internal passage in FIG. 5;

FIG. 7 is a view conceptually illustrating a vehicle including a storage tank-rail assembly according to various exemplary embodiments of the present disclosure;

FIG. 8 is a view exemplarily illustrating a state, in which a storage tank-rail assembly is further provided in the trunk in FIG. 7;

FIG. 9 is a view exemplarily illustrating a state, in which a storage tank-rail assembly is further provided on a rear side of a rear seat in the vehicle body in FIG. 8;

FIG. 10 is a view exemplarily illustrating a state, in which a storage tank-rail assembly is further provided on an upper side of the vehicle body in FIG. 9;

FIG. 11 is a perspective view of a storage tank assembly according to various exemplary embodiments of the present disclosure;

FIG. 12 is a perspective view of a connecting portion of a storage tank assembly according to various exemplary embodiments of the present disclosure;

FIG. 13 is a perspective view of a connecting portion of FIG. 12, viewed from another direction thereof;

FIG. 14 is a view exemplarily illustrating a state, in which a connecting portion of a storage tank-rail assembly is located in a first rail area according to various exemplary embodiments of the present disclosure; and

FIG. 15 is a view exemplarily illustrating a state, in which a connecting portion of a storage tank-rail assembly is located in a second rail area according to various exemplary embodiments of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted.

A storage tank assembly 100 according to an exemplary embodiment of the present disclosure may be a storage tank assembly which is used in a fuel cell electric vehicle (FCEV). For example, a fluid may be hydrogen. However, the present disclosure is not limited thereto, and is not limited as long as it is a fluid which may be used as a fuel.

Furthermore, the storage tank-rail assembly according to an exemplary embodiment of the present disclosure may include a structure including the storage tank assembly 100 and a rail 200. Furthermore, the vehicle according to an exemplary embodiment of the present disclosure may be a vehicle including the storage tank-rail assembly.

In the specification, a forward/rearward direction, a leftward/rightward direction, an upward/downward direction, and a vertical direction are referred to for convenience of description, and may be directions that are perpendicular to each other. However, the directions are determined relative to a direction, in which the storage tank assembly 100 is disposed, and the upward/downward direction may not necessarily mean the vertical direction.

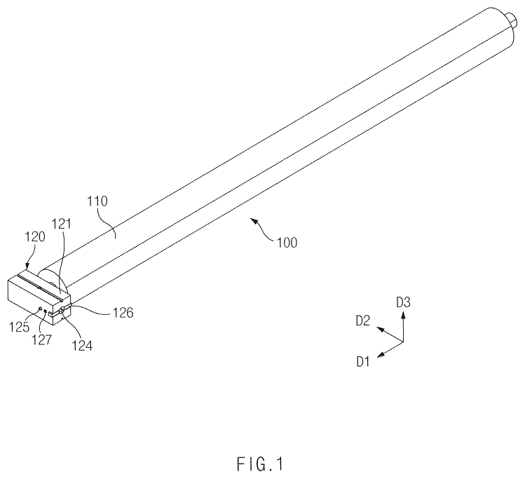

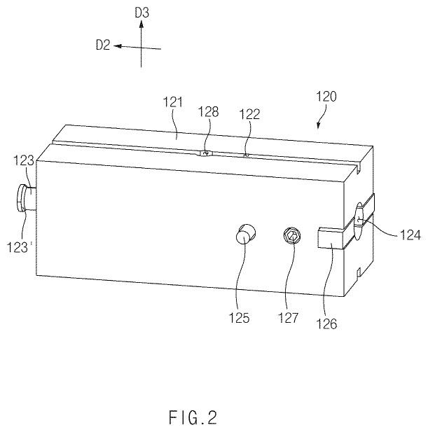

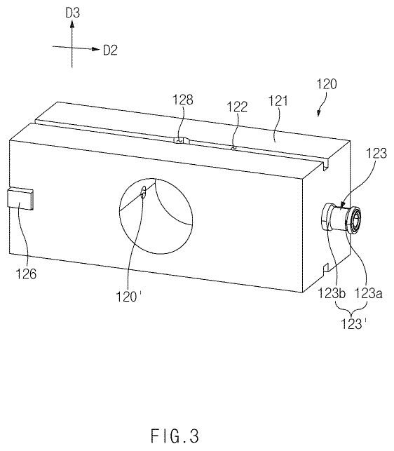

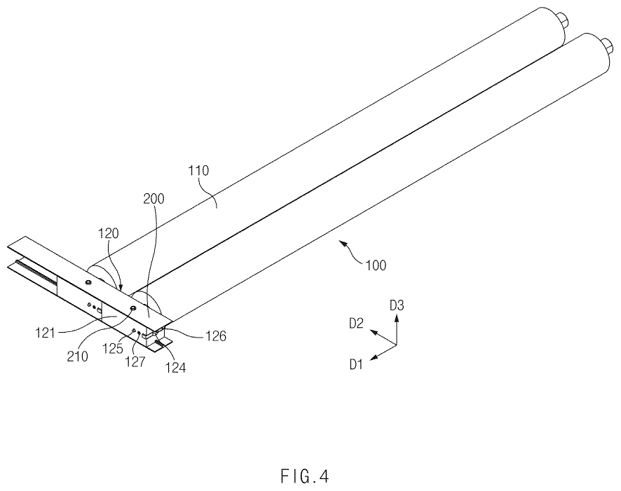

FIG. 1 is a perspective view of a storage tank assembly according to various exemplary embodiments of the present disclosure. FIG. 2 is a perspective view of a connecting portion of the storage tank assembly according to the various exemplary embodiments of the present disclosure. FIG. 3 is a perspective view of the connecting portion of FIG. 2, viewed from another direction thereof. FIG. 4 is a perspective view of a storage tank-rail assembly according to the various exemplary embodiments of the present disclosure.

The storage tank-rail assembly according to various exemplary embodiments of the present disclosure may include a storage tank assembly 100 and a rail 200. The rail 200 may be a subject which is coupled to the vehicle body “B”, and with which the storage tank assembly 100 is separably engaged.

Hereinafter, the storage tank assembly 100 will be described in detail. The storage tank assembly 100 may further include a storage tank 110 and a connecting portion 120.

The storage tank 110 may extend along a first direction D1, and may be configured so that a fluid is stored in an interior thereof. A discharge hole 111 may be formed at an end portion of the storage tank 110 in the first direction D1.

The connecting portion 120 may be coupled to the discharge hole 111, and an internal passage 120′ that fluidically communicates with the discharge hole 111 may be formed in an interior thereof. The connecting portion 120 may include a connecting portion body 121 and a rail insertion groove 122. The connecting portion body 121 may be a component, in which an internal passage 120′ is formed in an interior thereof. The rail insertion groove 122 may be a groove which is formed to be recessed from the connecting portion body 121, and into which a rail 200 which is provided on an outside of the connecting portion body 121 is inserted. The rail 200 may be coupled to the vehicle body “B”.

According to an exemplary embodiment of the present disclosure, because the connecting portion 120 may be slidably coupled to the rail 200 provided in the vehicle body “B”, the storage tank assembly 100 may be easily separated from or provided in the vehicle.

A plurality of storage tank assemblies 100 may be provided. The connecting portions 120 of the plurality of storage tank assemblies 100 may be connected to each other. That is, a plurality of storage tanks 110 and a plurality of connecting portions 120 may be provided. Accordingly, the numbers of storage tanks 110 and connecting portions 120 may correspond to each other.

Hereinafter, for convenience of description, a direction crossing the first direction D1 is referred to as a second direction D2. Furthermore, a direction that crosses the first direction D1 and the second direction D2 is referred to as the third direction D3.

The connecting portion 120 may include a protruding portion 123 and a groove portion 124. The protruding portion 123 may protrude from an end portion of the connecting portion body 121 in the second direction D2, along the second direction D2. An interior of the protruding portion 123 may fluidically communicate with an internal passage 120′. An O-ring for maintaining airtightness may be coupled to an end portion of the protruding portion 123 in the second direction D2. However, a method for maintaining airtightness is not limited to the O-ring, and of course, various types of members for maintaining airtightness, such as a metal seal, may be used.

The protruding portion of, among the plurality of connecting portions 120, the connecting portion which is located on a side in the second direction D2 may be connected to a manifold, to which a fixed storage tank “T”, which will be described later, is connected, or to a pipeline which is connected to a regulator whereby a fluid may be supplied to a site on demand.

The groove portion 124 may be recessed at an end portion of the connecting portion body 121 in an opposite direction to the second direction D2, along the second direction D2. The groove portion 124 may also fluidically communicate with the internal passage 120′. The groove portion 124 may be a configuration for inserting a protruding portion of another adjacent connecting portion.

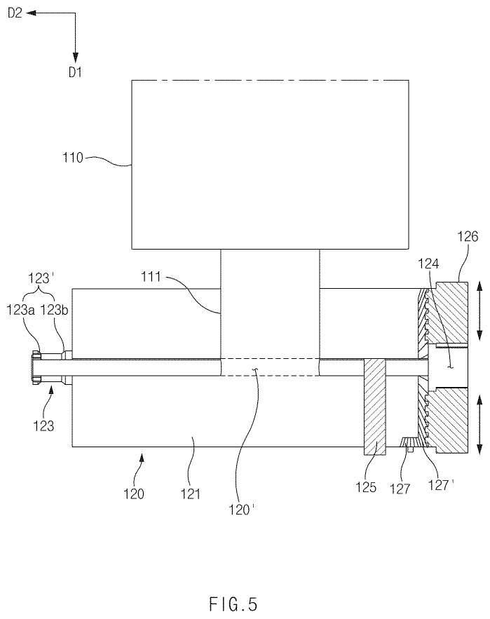

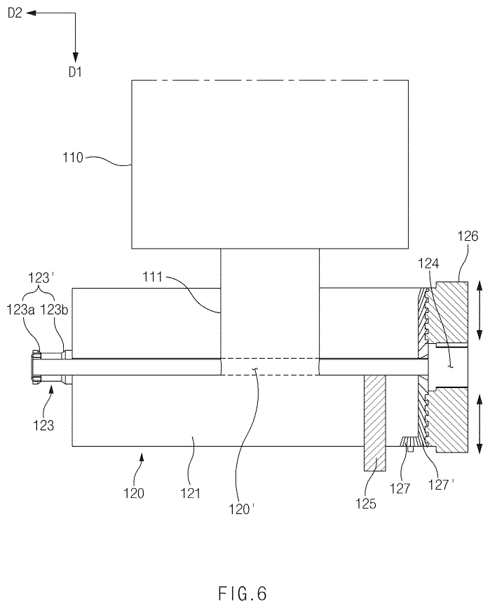

FIG. 5 is a cross-sectional view of the storage tank assembly according to various exemplary embodiments of the present disclosure. FIG. 6 is a view exemplarily illustrating a state, in which a valve member closes the internal passage in FIG. 5.

The connecting portion 120 may further include a valve member 125. The valve member 125 may pass through the connecting portion body 121 along the first direction D1 and an opposite direction thereto. When viewed along the first direction D1, the valve member 125 may be disposed to overlap the internal passage 120′ to selectively close the internal passage 120′. Here, selectively closing means that the internal passage 120′ is not closed when the valve member 125 is not disposed in the internal passage 120′, but the internal passage 120′ is closed when the valve member 25 is moved so that the valve member 125 is disposed in the internal passage 120.

The valve member 125 may be located on a side of the discharge hole 111 in an opposite direction to the second direction D2. This may mean that the valve member 125 is disposed adjacent to the groove portion 124. This may be for preventing the fluid from being leaked through the groove portion 124 when the protruding portion 123 of another adjacent connecting portion 120 is separated from the groove portion 124 later. That is, when the protruding portion 123 of another adjacent connecting portion 120 is separated, the valve member 125 may be moved to close the internal passage 120′.

The connecting portion 120 may include a constraint member 126 and a movement member 127. The constraint member 126 may be configured a portion thereof disposed in the groove portion 124 to constrain the protruding portion 123 of another connecting portion 120 which is inserted into the groove portion 124. The movement member 127 may be connected to the constraint member 126, and may be configured to move the constraint member 126 to become farther away from or closer to the protruding portion 123.

For example, the constraint member 126 and the movement member 127 may include a structure which is similar to that of an interlocking chuck structure or a single-acting chuck structure which is used in a lathe. As an exemplary embodiment of the present disclosure, a bevel gear 127′ including a spiral groove on one surface thereof may be disposed between the constraint member 126 and the movement member 127. This means that as the movement member 127 rotates, it may include a structure that moves the constraint member 126 so that the constraint member 126 becomes farther away from or closer to the protruding portion 123.

The protruding portion 123 may include an inclined area 123′. The inclined area 123′ may be an area, a diameter of which increases along the second direction D2 or the opposite direction thereto. As an exemplary embodiment of the present disclosure, the inclined area 123′ may include a first inclined area 123a, a diameter of which increases along the second direction D2. Furthermore, the inclined area may include a second inclined area 123b, a diameter of which increases along an opposite direction to the second direction D2.

Accordingly, the protruding portion 123 may be pressed in the second direction D2 or the opposite direction thereto when the inclined area 123′ contacts with the constraint member 126. For example, when the constraint member 126 and the first inclined area 123a contact with each other, the protruding portion 123 may be pressed along an opposite direction to the second direction D2. As an exemplary embodiment of the present disclosure, when the constraint member 126 and the second inclined area 123b contact with each other, the protruding portion 123 may be pressed along the second direction D2.

In the instant case, because the protruding portion 123 may be pressed in the second direction D2 and may be moved in the second direction D2 as the constraint member 126 contacts with the first inclined area 123a in a process of moving the constraint member 126 toward the protruding portion 123 even when the protruding portion 123 is not disposed at an exact position in the groove portion 124, the protruding portion 123 may be disposed at an exact portion in the groove portion 124 whereby an assembling performance may be improved.

The connecting portion 120 may further include a fastening hole 128 (see FIG. 2 and FIG. 3). The fastening hole 128 may be formed on a side of the connecting portion body 121 in at least one of the third direction D3 or the opposite direction thereto. A fastening member may be inserted into the fastening hole 128. The fastening member may pass through the rail 200 along the third direction D3 or the opposite direction thereto. The fastening member may pass through the rail fastening hole 210 formed in the rail 200. This may mean that the fastening member is a member that connects the rail 200 and the connecting portion 120 as it passes through the rail fastening hole 210 and is inserted into the fastening hole 128.

The rail insertion groove 122 may be formed on a side of the connecting portion body 121 in at least one of the third direction D3 or the opposite direction thereto, and may extend along the second direction D2. This may mean that the rail 200 is located on a side of the connecting portion body 121 in at least one of the third direction D3 or the opposite direction thereto. The fastening hole 128 and the rail insertion groove 122 may fluidically communicate with each other.

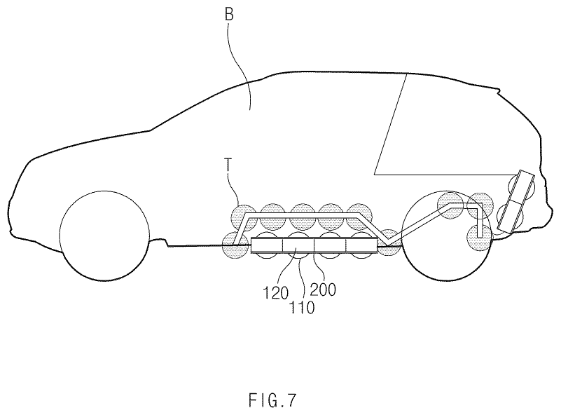

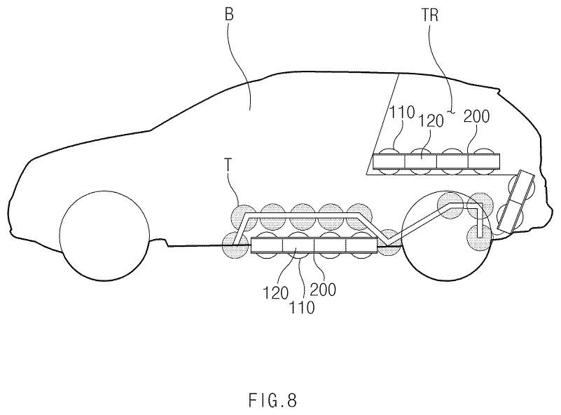

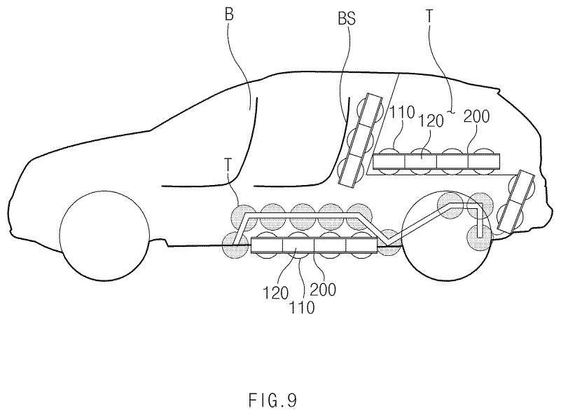

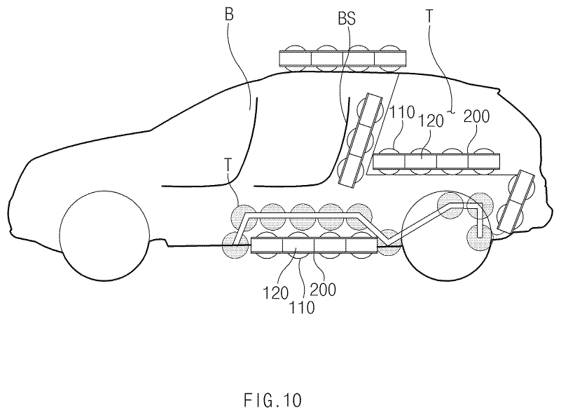

FIG. 7 is a view conceptually illustrating a vehicle including the storage tank-rail assembly according to the various exemplary embodiments of the present disclosure. FIG. 8 is a view exemplarily illustrating a state, in which the storage tank-rail assembly is further provided in a trunk in FIG. 7. FIG. 9 is a view exemplarily illustrating a state, in which the storage tank-rail assembly is further provided on a rear side of a rear seat in the vehicle body in FIG. 8. FIG. 10 is a view exemplarily illustrating a state, in which a storage tank-rail assembly is further provided on an upper side of the vehicle body in FIG. 9.

Hereinafter, the vehicle including the storage tank-rail assembly described above will be described in detail based on FIG. 7, FIG. 8, FIG. 9 and FIG. 10 and the above-described contents. For components that are identical or equivalent to the storage tank-rail assembly described above, the same or equivalent reference numerals are assigned, and a detailed description thereof will be omitted.

The vehicle may include the vehicle body “B”, the storage tank assembly 100, and the rail 200. Accordingly, the rail 200 may be coupled to at least one of a lower portion of the vehicle body “B”, the trunk TR of the vehicle body “B”, a rear side of a rear seat BS in the vehicle body “B”, and an upper portion of the vehicle body “B”. However, a disposition position of the rail 200 is not limited thereto, and the rail 200 may be disposed by utilizing a free space in the vehicle body “B”.

Accordingly, the storage tank assembly 100 may be separated from the rail 200 or mounted on the rail 200. This may mean that the user may dispose the storage tank-rail assembly 100 at a site on demand or may further install or remove it as needed.

The vehicle may further include a fixed storage tank “T”. The fixed storage tank “T” may be fixedly coupled to the vehicle body “B”, and may be configured to keep a fluid in an interior thereof.

The storage tank assembly 100 may have an advantage of being detachable, but may have a disadvantage in terms of weight when considering the structure of the connecting portion 120. Accordingly, the fixed storage tank “T”, which has an advantage in terms of weight, may be partially disposed in the vehicle body “B” to secure a basic range, and the storage tank assembly 100 may be additionally applied to determine a total fluid capacity according to the needs of the user.

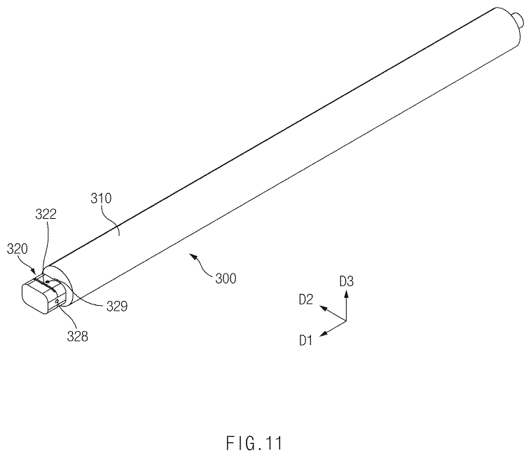

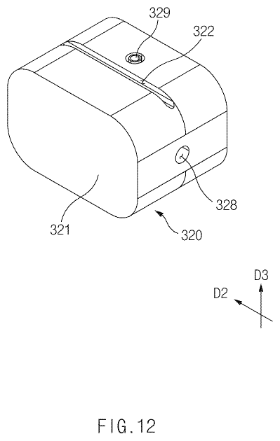

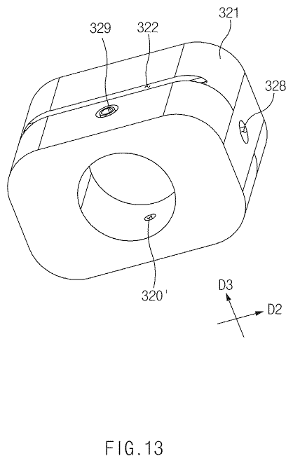

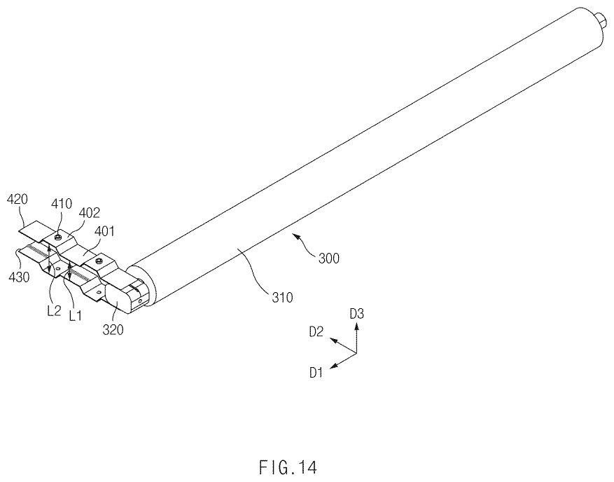

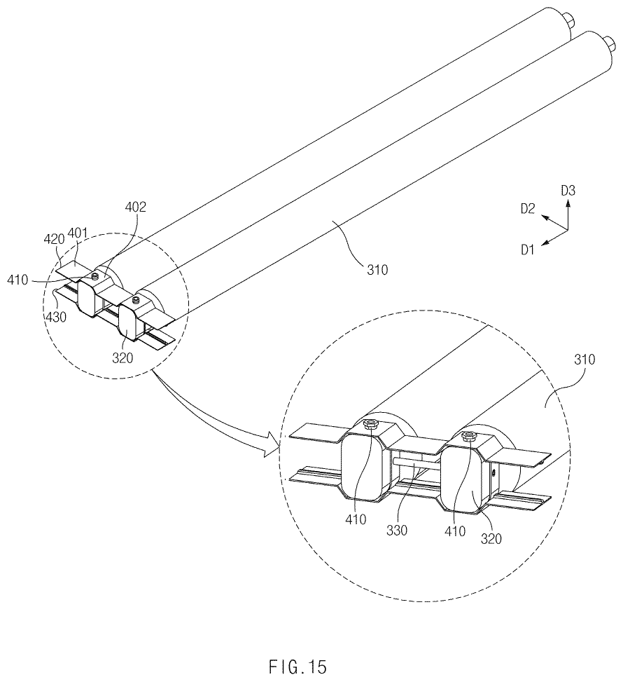

FIG. 11 is a perspective view of a storage tank assembly according to various exemplary embodiments of the present disclosure. FIG. 12 is a perspective view of a connecting portion of the storage tank assembly according to the various exemplary embodiments of the present disclosure. FIG. 13 is a perspective view of the connecting portion of FIG. 12, viewed from another direction thereof. FIG. 14 is a view exemplarily illustrating the connecting portion of a storage tank-rail assembly according to the various exemplary embodiments of the present disclosure located in a first rail area. FIG. 15 is a view exemplarily illustrating the connecting portion of the storage tank-rail assembly according to the various exemplary embodiments of the present disclosure located in a second rail area.

Hereinafter, the storage tank-rail assembly according to the various exemplary embodiments will be described in detail based on FIG. 11, FIG. 12, FIG. 13, FIG. 14 and FIG. 15 and the above-described contents. The storage tank-rail assembly according to the various exemplary embodiments are different from the storage tank-rail assembly according to the various exemplary embodiments in the shapes of a connecting portion 320 and a rail 400. For components that are identical or equivalent to the storage tank-rail assembly described above, the same or equivalent reference numerals are assigned, and a detailed description thereof will be omitted.

The storage tank assembly 300 may include a storage tank 310 and a connecting portion 320. A rail insertion groove 322 is formed in a connecting portion body 321 of the connecting portion 320 and may be engaged with the rail 400. The rail 400 may include a pair of rail members. The pair of rail members may be spaced from each other along the third direction D3.

The rail 400 may include a first rail area 401 and a second rail area 402. The first rail area 401 may be an area, in which a spacing distance of the pair of rail members is a first spacing distance L1. The second rail area 402 may be an area, in which the spacing distance of the pair of rail members is a second spacing distance L2. The second spacing distance L2 may be greater than the first spacing distance L1. The first rail area 401 and the second rail area 402 may be alternately disposed along the second direction D2.

A length of the connecting portion body 321 in the third direction D3 may correspond to the first spacing distance L1. Furthermore, a length of the connecting portion body 321 in the second direction D2 may correspond to the second spacing distance L2. Accordingly, a disposition state of the connecting portion body 321 is based on when the connecting portion 320 is located in the first rail area 401, as in the state of FIG. 14.

The connecting portion 320 may further include a fastening hole 328. The fastening hole 328 may be formed on a side of the connecting portion body 321 in at least one of the second direction D2 or the opposite direction thereto.

The rail 400 may further include a rail fastening hole 410. The rail fastening hole 410 may be formed in the second rail area 402, and may fluidically communicate with the fastening hole 328 so that a fastening member may pass therethrough.

As the connecting portion 320 is located in the second rail area 402 and is disposed to be rotated by 90 degrees from a state, in which it is located in the first rail area 401, the fastening hole 328 and the rail fastening hole 410 may fluidically communicate with each other.

The connecting portion 320 may further include a connecting member 329 and a hose member 330. The connecting member 329 may be a portion which is formed on a side of the connecting portion body 321 in the second direction D2 and the opposite direction thereto, and is selectively positioned in a communication state, in which it fluidically communicates with an internal passage 320′ or in a closed state, in which it is not communicated with the internal passage 320′. Here, being selectively positioned in the communicating state or the closed state may mean that the communicating state occurs when the hose member 330 is connected, and the closed state occurs when the hose member 330 is separated.

As an exemplary embodiment of the present disclosure, the connecting member 329 may include an opening, a closing portion which is configured to close the opening, and an elastic portion that elastically supports the closing area. The closing portion may include a structure that opens the opening as it is pushed by the hose member 330, and closes the opening again by the elastic portion when the hose member 330 is removed.

The hose member 330 is configured to be engaged with the connecting member 329, and may be configured to switch the connecting member 329 from the closed state to the communication state when being engaged with the connecting member 329. The hose member 330 may be formed of a flexible material.

In the case of the storage tank-rail assembly according to the various exemplary embodiments of the present disclosure, because the connecting portion 320 may not be disposed in the first rail area 401 and the connecting portion 320 may be disposed in the second rail area 402, the spacing distance between the storage tanks 310 may be secured, collisions between the storage tanks 310 may be prevented, and an influence of the storage tanks 310 on each other may be reduced.

The rail 400 may include an upper rail member 420 and a lower rail member 430. The lower rail member 430 may be disposed on a lower side of the upper rail member 420 to be symmetrical thereto. Accordingly, opposite end portions of the lower rail member 430 may be fixed to the vehicle body “B”. Furthermore, one end portion of the upper rail member 420 may be fixed to the vehicle body “B” to allow changes due to pressing of the connecting portion 320.

Because the connecting portion 320 includes a structure, in which the length thereof in the second direction D2 is greater than the length thereof in the third direction D3, the distance between the upper rail member 420 and the lower rail member 430 needs to be temporarily increased to rotate the connecting portion 320 by 90 degrees in the second rail area 402. However, in the case of the lower rail member 430, the connecting portion 320 has to be supported upward, and thus opposite end portions of the lower rail member 430 may be fixedly coupled to the vehicle body “B” whereas a portion of the upper rail member 420 may be coupled to the vehicle body “B” so that it may be moved.

According to an exemplary embodiment of the present disclosure, a separate storage tank may be attached to and detached from the vehicle, so that the range may be increased by adding a storage tank, or the weight of the vehicle may be reduced by removing an unnecessary storage tank to increase an operating efficiency.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A storage tank assembly comprising:
a storage tank extending along a first direction, configured to store a fluid in an interior thereof, and including a discharge hole at an end portion of the storage tank in the first direction; and
a connecting portion coupled to the discharge hole, and including an internal passage fluidically-communicating with the discharge hole, in an interior of the connecting portion,
wherein the connecting portion includes:
a connecting portion body including the internal passage in an interior of the connecting portion body; and
a rail insertion groove formed to be recessed from the connecting portion body and configured so that a rail provided on an outside of the connecting portion body is selectively inserted into the rail insertion groove.

2. The storage tank assembly of claim 1,
wherein a second direction is defined as one direction crossing the first direction, and
wherein the connecting portion further includes:
a protruding portion protruding from an end portion of the connecting portion body in the second direction along the second direction, and an interior of which fluidically communicates with the internal passage; and
a groove portion formed to be recessed from an end portion of the connecting portion body in an opposite direction to the second direction along the second direction, and fluidically-communicating with the internal passage.

3. The storage tank assembly of claim 2, wherein the connecting portion further includes:
a valve member passing through the connecting portion body along the first direction and an opposite direction to the first direction, disposed to overlap the internal passage in the first direction, and configured to selectively close the internal passage.

4. The storage tank assembly of claim 3, wherein the valve member is located on a side of the discharge hole in the opposite direction to the second direction.

5. The storage tank assembly of claim 2,
wherein a plurality of storage tanks and a plurality of connecting portions are provided, and
wherein each of the connecting portions includes:
a constraint member configured so that a portion thereof is disposed at the groove portion to constrain a protruding portion of another connecting portion inserted into the groove portion; and
a movement member engaged to the constraint member, and configured to move the constraint member so that the constraint member becomes farther away from or closer to the protruding portion in operation of the movement member.

6. The storage tank assembly of claim 5, wherein the protruding portion includes:
an inclined area being an area, a diameter of which increases along the second direction or the opposite direction to the second direction, and
wherein the protruding portion is pressed in the second direction or the opposite direction to the second direction in a state that the inclined area contacts with the constraint member.

7. The storage tank assembly of claim 2,
wherein a third direction is defined as one direction crossing the first direction and the second direction, and
wherein the connecting portion further includes:
a fastening hole formed on a side of the connecting portion body in at least one of the third direction or an opposite direction to the third direction, and configured so that a fastening member passing through the rail along the third direction or the opposite direction to the third direction is inserted thereinto.

8. The storage tank assembly of claim 7, wherein the rail insertion groove is formed on a side of the connecting portion body in the third direction or the opposite direction to the third direction, and extending along the second direction.

9. The storage tank assembly of claim 8, wherein the fastening hole and the rail insertion groove fluidically communicate with each other.

10. The storage tank assembly of claim 1,
wherein a second direction is defined as one direction crossing the first direction, and
wherein the connecting portion includes:
a connecting member formed on a side of the connecting portion body in the second direction or the opposite direction to the second direction, and selectively positioned in a communication state, in which the connecting member fluidically communicates with the internal passage, and a closed state, in which the connecting member is not communicated with the internal passage; and
a hose member configured to be engaged with the connecting member, and configured to switch the connecting member from the closing state to the communication state when being engaged with the connecting member.

11. A storage tank-rail assembly comprising:
a storage tank assembly including a storage tank extending along a first direction, and a connecting portion connected to a side of the storage tank in the first direction; and
a rail extending in a second direction being one direction crossing the first direction, and engaged with the connecting portion,
wherein a discharge hole is formed at an end portion of the storage tank in the first direction, and
wherein the connecting portion includes:
a connecting portion body including an internal passage fluidically-communicating with the discharge hole, in an interior of the connecting portion; and
a rail insertion groove formed to be recessed from the connecting portion body, and configured so that the rail is inserted thereinto.

12. The storage tank-rail assembly of claim 11,
wherein a plurality of storage tank assemblies are provided, and
wherein connecting portions of the plurality of storage tank assemblies are connected to each other.

13. The storage tank-rail assembly of claim 12, wherein the connecting portion further includes:
a protruding portion protruding from an end portion of the connecting portion body in the second direction along the second direction, and fluidically-communicating with the internal passage; and
a groove portion formed to be recessed from an end portion of the connecting portion body in an opposite direction to the second direction along the second direction, and fluidically-communicating with the internal passage, and
wherein a protruding portion of another connecting portion is inserted into a groove portion of any one connecting portion.

14. The storage tank-rail assembly of claim 12,
wherein a third direction is defined as one direction crossing the first direction and the second direction,
wherein the rail includes a pair of rail members spaced from each other along the third direction,
wherein the rail includes:
a first rail area, in which a spacing distance of the pair of rail members is a first spacing distance; and
a second rail area, in which the spacing distance of the pair of rail members is a second spacing distance being greater than the first spacing distance; and
wherein the first rail area and the second rail area are alternately disposed along the second direction.

15. The storage tank-rail assembly of claim 14,
wherein the rail insertion groove is formed on one side of the connecting portion body in at least one of the third direction or an opposite direction to the third direction, and extends along the second direction,
wherein a length of the connecting portion body in the third direction corresponds to the first spacing distance, and
wherein a length of the connecting portion body in the second direction corresponds to the second spacing distance.

16. The storage tank-rail assembly of claim 15, wherein the connecting portion further includes:
a fastening hole formed on a side of the connecting portion body in at least one of the second direction or an opposite direction to the second direction,
wherein the rail further includes:
a rail fastening hole formed in the second rail area, and fluidically-communicating with the fastening hole to pass through a fastening member, and
wherein the connecting portion is located in the second rail area, and the fastening hole and the rail fastening hole fluidically communicate with each other as the connecting portion is disposed in a state, in which the connecting portion is rotated by 90 degrees from a state, in which the connecting portion is located in the first rail area.

17. A vehicle comprising:
a vehicle body;
a storage tank assembly including a storage tank extending along a first direction, and a connecting portion connected to a side of the storage tank in the first direction; and
a rail extending in a second direction being one direction crossing the first direction, engaged with the connecting portion, and coupled to the vehicle body,
wherein the storage tank assembly is separably engaged with the rail.

18. The vehicle of claim 17, wherein the rail is coupled to at least one of a lower portion of the vehicle body, a trunk of the vehicle body, a rear side of a rear seat in the vehicle body, and an upper portion of the vehicle body.

19. The vehicle of claim 17, wherein the rail includes:
an upper rail member; and
a lower rail member disposed on a lower side of the upper rail member to be symmetrical thereto,
wherein opposite end portions of the lower rail member are fixed to the vehicle body, and
wherein one end portion of the upper rail member is fixed to the vehicle body to allow a change due to pressing of the connecting portion.

20. The vehicle of claim 17, further including:
a fixed storage tank fixedly coupled to the vehicle body, and configured so that a fluid is kept in an interior of the fixed storage tank.
